(19) United States
(12) Patent Application Publication
(10) Pub. No.: US 2021/0251207 A1
(43) Pub. Date: Aug. 19, 2021

(54) MULTI-MOUNT PORTABLE STORAGE CONSOLE

(71) Applicant: Innovative Outdoor Solutions, Inc., Maple Lake, MN (US)

(72) Inventors: Troy Tufto, Maple Lake, MN (US); Kevin Ziebarth, Maple Lake, MN (US)

(73) Assignee: Innovative Outdoor Solutions, Inc., Maple Lake, MN (US)

(21) Appl. No.: 16/793,500

(22) Filed: Feb. 18, 2020

(51) Int. Cl. A01K 97/06; A01K 97/01; A01K 97/05

(52) U.S. Cl. CPC A01K 97/06; A01K 97/05; A01K 97/01

(57) ABSTRACT

One example provides a portable storage console including a body having an upper major surface including a number of storage compartments, and a lower major surface opposing the upper major surface. The lower major surface includes at least a first channel and a second channel, the first channel to selectively receive a component of a first fixture to releasably mount the storage console to the first fixture, and the second channel to selectively receive a component of a second fixture to releasably mount the storage console to the second fixture.

### BACKGROUND

Ice fishing is a popular winter sport for which a wide variety of equipment has been developed. Because fish are not predictable, it important for a fisherman to be able to easily move from location to location, both to different locations on a same lake and to different lakes altogether.

### SUMMARY

A portable storage console including a body having an upper major surface including a number of storage compartments, and a lower major surface opposing the upper major surface. The lower major surface includes at least a first channel and a second channel, the first channel to selectively receive a component of a first fixture to releasably mount the storage console to the first fixture, and the second channel to selectively receive a component of a second fixture to releasably mount the storage console to the second fixture.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view generally illustrating a portable storage console, according to one example.

FIG. 2 is a side view generally illustrating the portable storage console of FIG. 1, according to one example.

FIG. 3 is a bottom view generally illustrating the portable storage console of FIG. 1, according to one example.

FIG. 4 is a perspective view generally illustrating a portable outdoor activity shelter suitable for use with a portable storage console, according to one example.

FIG. 5 is a cross-sectional view generally illustrating a portable storage console mounted to a portable outdoor activity shelter, according to one example.

FIG. 6 is a perspective view generally illustrating a portable storage console mounted to a bucket, according to one example.

FIG. 7 is a top view generally illustrating a portable storage console, according to one example.

FIG. 8 is an end view generally illustrating a portable storage console, according to one example.

FIG. 9 is an end view generally illustrating a portable storage console, according to one example.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims. It is to be understood that the features of the various exemplary embodiments described herein may be combined with each other, unless specifically noted otherwise.

Ice fishing is a popular winter sport for which a wide variety of equipment has been developed. Because fish are not predictable, it important for a fisherman to be able to easily move from location to location, both to different locations on a same lake and to different lakes.

With this in mind, portable ice fishing shelters have been developed, where such shelters generally include a base (e.g., a sled or tub), to which a collapsible frame and flexible outer covering are attached. The frame and outer covering can be quickly converted back-and-forth between a deployed position to form an enclosure, and a collapsed or stowed position on or within the sled for transport.

Within the confines of a portable ice fishing shelter, it is beneficial to store and organize a wide variety of fishing equipment (e.g., poles, jigs, lures, live bait, bobbers) and other gear (e.g., tools, flashlights, cell phones, car keys, beverages). It is also beneficial to be able to easily move and utilize such items to different locations within the shelter and to locations beyond the ice fishing shelter.

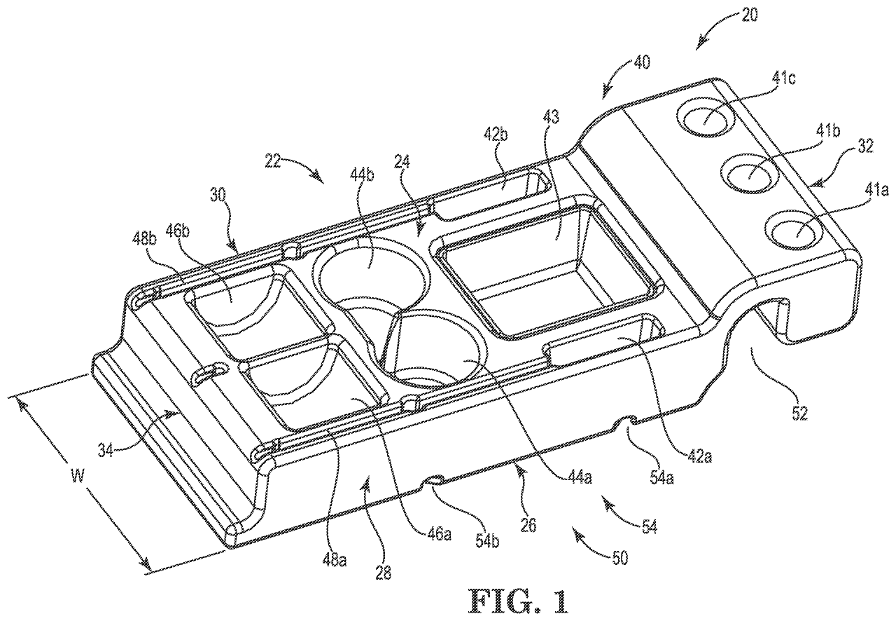

FIG. 1 is a perspective view of a portable storage console 20 for storing a variety of items. In examples, as described in greater detail herein, portable storage console 20 is selectively mountable to multiple fixtures, such as to a base portion (e.g., a sled or tub) of a portable ice fishing shelter and to an upper rim of a bucket (e.g., a 5-gallon bucket, which is ubiquitous among fishermen), or any other suitable item. As will be described in greater detail below, activity console 20 is readily moveable, without a need for tools, between such fixtures to enable portability and transport of items stored therein.

In one example, activity console 20 includes a body 22 having a first or upper major surface 24, an opposing second or lower major surface 26, a first longitudinal or side surface 28, an opposing second longitudinal or side surface 30, a first transverse or end surface 32, and an opposing second transverse of end surface 34. Although illustrated herein primarily as being rectangular in shape, it is noted that console 20 may have any number of shapes and dimensions.

In examples, upper major surface 24 includes a number of compartments 40 extending into body 22 toward lower major surface 26 for storing a variety of items and equipment. In one example, compartments 40 include a number of cylindrical compartments 41a-41c, such as for receiving a handle portion of a fishing pole to store unused poles, a number of rectangular compartments 42a and 42b, such as for holding cell phones, for example, a number of bin-like containers 43 (one in the illustrated example) for storing miscellaneous items (e.g., keys. flashlights, tape measures, tools), a number of cylindrical compartments 44a and 44b, such as for holding beverage containers, a number of compartments 46a and 46b having curved bottoms (e.g., semi-cylindrical) for storing cylindrical items, such as fishing line spools and bait containers, for example, and a number of channels 48a and 48b, such as for receiving fishing rod holders. It is noted that compartments 40 and the arrangement thereof, as illustrated by FIG. 1, represents only one example of such compartments 40, and that console 20 may include any number of compartment shapes, sizes, and arrangements, in addition to that illustrated in FIG. 1. Additionally, although illustrated as being disposed in upper major surface 24, it is noted that, in other examples, compartments may be formed in other surfaces of main body 22.

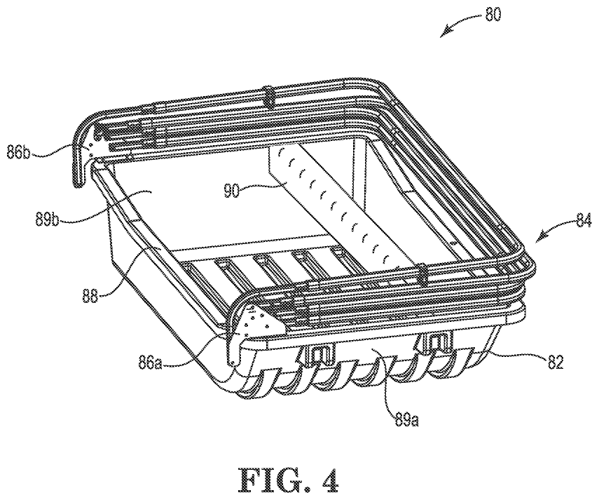

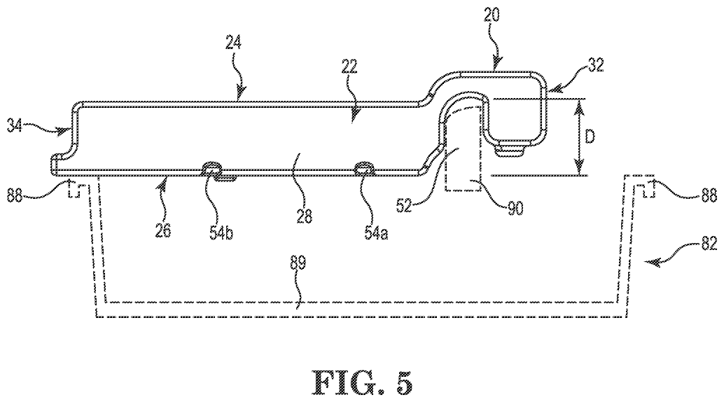

In one example, main body 22 includes a number of mounting channels 50 extending across and into bottom major surface 26 toward upper major surface 24, such as mounting channels 52 and 54, where each of the mounting channels is to slideably receive a portion of a different fixture so as to releasably secure console 20 to such fixture. In one example, mounting channel 52 extends across bottom major surface 26 between first and second side surfaces 28 and 30, with mounting channel 52 extending into main body 22 from bottom major surface 26 toward upper major surface 24, such that mounting channel 52 is flush with bottom major surface 26. In one example, as illustrated, mounting channel 52 is a linear channel. In one example, mounting channel 52 extends transversely across bottom major surface 26 between first and second side surfaces 28 and 30. In one example, as will be described in greater detail below (e.g., see FIGS. 4 and 5), a fixture (or a portion of a fixture) to be received by mounting channel 52 is an element (e.g., a support beam element) of a base portion of a portable ice fishing shelter.

In one example, as will be described in greater detail below, mounting channel 50 comprises an arcuate mounting channel 54 in bottom major surface 26, with arcuate mounting channel 54 extending into main body 22 from bottom major surface 26 toward upper major surface 24, such that mounting channel 52 is flush with bottom major surface 26. In one example, as illustrated, arcuate mounting channel 54 includes a first arcuate segment 54a and a second arcuate segment 54a, where, as will be described in greater detail below, arcuate mounting channel 54 is configured to slideably receive an upper rim of a 5-gallon bucket (or other fixture having a similar rim) such that portable console 20 may be mounted to such bucket.

In one example, console 20 is formed from a single, contiguous piece of molded plastic material. In one example, as will be illustrated in greater detail below, main body 22 has a width, W, in the transverse direction, which is less than a diameter of a conventional 5-gallon bucket. With main body 22 having a width, W, less than a diameter of a conventional 5-gallon bucket, in some examples, depending on a type of handle being employed by a particular bucket, main body 22 may pass under a handle of the bucket so that the handle can be used to carry the bucket with console 20 mounted to the upper rim thereof. For example, with buckets employing plastic handles, the plastic handles may typically be placed over console 20.

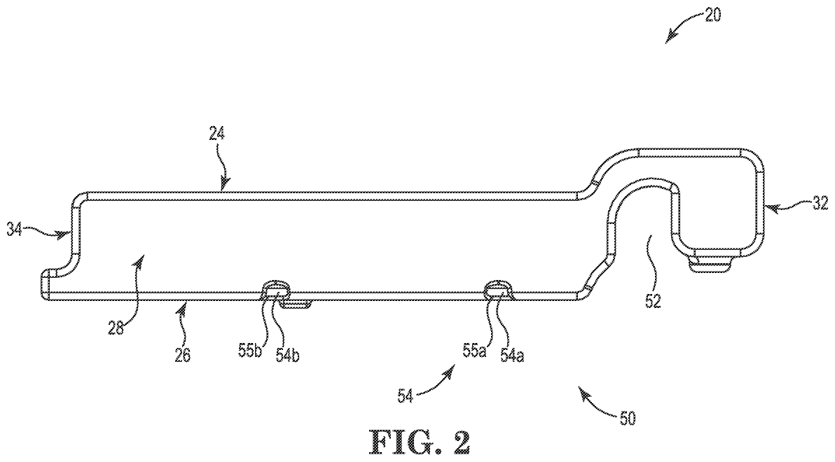

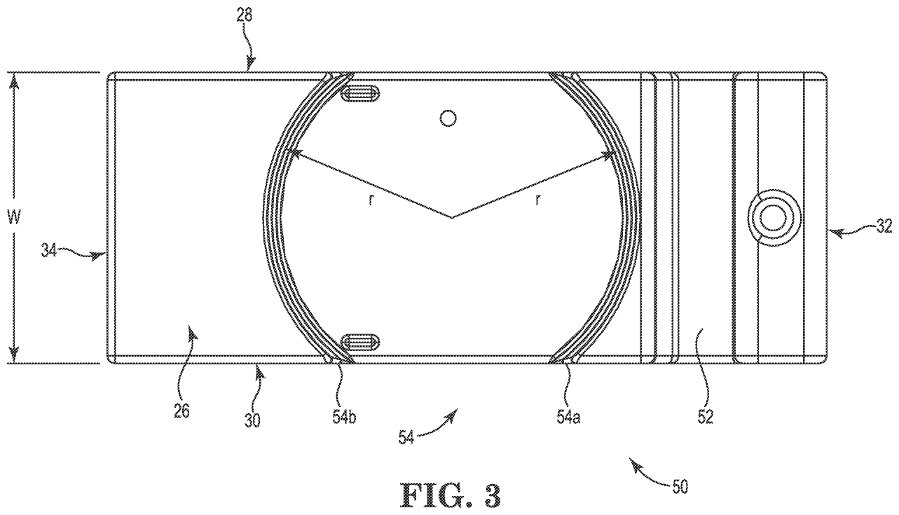

FIGS. 2 and 3 respectively illustrate side and bottom views of console 20, according to one example. As illustrated, in on example, mounting channel 52 extends linearly across the width, W, of bottom major surface 26 between first and second sides 28 and 30. In one example, as illustrated, with the width, W, of bottom major surface 26 being less than a diameter of a top rim of a 5-gallon bucket, arcuate mounting channel 54 comprises first and second arcuate channel segments 54a and 54b extending across bottom major surface 26 between first and second sides 28 and 30. In one example, first and second arcuate channel segments 54a and 54b each have a radius, r, equal to that of a standard 5-gallon bucket. In one example, a mouth 55 of mounting channel 54, illustrated as mouths 55a and 55b of arcuate channel segments 54a and 54b, is flush with bottom major surface 26 (i.e., does not extend beyond bottom major surface 55 in a direction away from upper major surface 24. In one example (not illustrated), if the width, W, is greater than a diameter of a 5-gallon bucket, arcuate mounting channel 54 may comprises a continuous, circular mounting channel for receiving the entire circumference of a top rim of the bucket.

FIG. 4 is a perspective view generally illustrating an example of a portable outdoor activity shelter 80, with which portable console 20 may be used, according to one example. Shelter 80 includes a sled 82 to which a collapsible frame and cover system 84 is mounted via a pair of mounting brackets 86a and 86b. Frame and cover system 84 is illustrated in a collapsed or stowed position in FIG. 4, but is rotatable about mounting brackets 86a and 86b to a deployed position (not illustrated) where the frame and cover system 84 forms an enclosure having an interior space, including about sled 82. The cover system 84 may be returned to the collapsed via rotation about mounting brackets 86a and 86b and gathered or stowed in an accordion-like fashion along an upper perimeter edge 88 of sled 82, as illustrated. In one example, a support beam 90 extends longitudinally across sled 82 between opposing ends 89a and 89b, and to which a number of accessories may be mounted (e.g., detachable seats), including portable console 20.

FIG. 5 is a cross-sectional view of portions of outdoor activity shelter 80 of FIG. 4 generally illustrating portable console 20 mounted thereto, according to one example. Portable console 20 is positioned with bottom major surface 26 facing sled 82 such that mounting channel 52 slideably receives support beam 90 and bottom major surface 26 proximate to second end surface 34 rests on top edge or rim 88 of sled 82. In one example, mounting channel 52 has a depth, D, relative to bottom major surface 26 such that when support beam 90 is seated within mounting channel 52, bottom major surface 26 rests on rim 88 of sled 82 such that upper and lower major surfaces 24 and 26 are substantially in parallel with a bottom 89 of sled 82.

With reference to FIG. 4, when mounted to sled 82, console 20 may readily be slid along support beam 90 and rim 88 so as to be positioned at any desired location between opposing ends 89a and 89b, so as to enable easy access to items stored within sled 82 or to position console 20 at a desired position relative to seats mounted on support beam 90, for example. In one case, when a single seat is mounted to support beam 90 (not illustrated), console 20 may readily be mounted to support beam 90 on either side of such seat. In a scenario where two seats are mounted to support beam 90 (not illustrated), console 20 may mounted to support beam 90 so as to be positioned between such pair of seats.

Although portable ice fishing shelters are convenient and provide protection against the elements, fisherman do not always remain within such enclosures or even use such enclosures. For example, because fish are unpredictable, even when using a portable shelter, a fisherman may wish to try fishing at different locations on the lake without moving the enclosure, or simply may want to fish outside the enclosure in nice weather. Additionally, a fisherman may not own an enclosure or may simply choose not to use an enclosure. In such cases, nearly every ice fisherman transports fishing equipment and gear in one or more 5-gallon buckets, which are universally used and serve many purposes among ice fisherman (e.g., holding equipment, holding fish, as a stool).

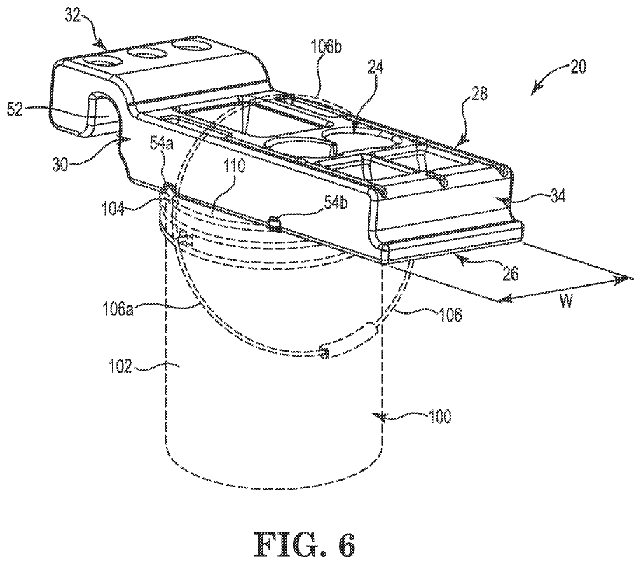

FIG. 6 is a perspective generally illustrating console 20 mounted to a top rim of a 5-gallon bucket 100 via arcuate mounting channel segments 54a and 54b in bottom major surface 26. As illustrated, bucket 100 has a cylindrical sidewall 102 having an upper rim 104 defining an open top of bucket 100. A handle 106 is mounted proximate to upper rim 104, which is pivotable between a resting position 106a and a transport position 106b (when bucket 100 is being carried, for example).

As illustrated, to mount console 20 on bucket 100, console 20 is positioned with bottom major surface 26 facing bucket 100 such that first and second arcuate mounting channel segments slideably receive portions of radially opposing sides of top rim 104 of bucket 100. In one example, as illustrated, when a transverse width, W, of console 20 is less than a diameter of bucket 100 at upper rim 104, when mounting console 20 to top rim 104 via first and second arcuate mounting channel segments 54a and 54b, handle 106 may be placed in transport position 106b such that console may be positioned between handle 106 and top rim 104. In some examples, such as when handle 106 comprises a plastic handle, such positioning enables bucket 104 to be transported via handle 106 with console 20 mounted thereto. Upon reaching a desired location, console 20 may be temporarily removed from bucket 100 to enable handle 106 to be placed in resting position 106a, at which point console 20 once again be mounted to top rim 104, where console 20 is readily therefrom to enable access to an interior of bucket 100.

As illustrated, when mounted to bucket 100, console 20 receives top rim 104 within arcuate mounting channel segments 54a, 54b so as to be retained on top of bucket 100 with upper major surface 24 exposed to provide easy access to items stored within storage compartments 40. As illustrated, in one example, console 20 extends beyond the circumferential perimeter of bucket 100 in a longitudinal direction between first and second ends surfaces 32 and 34, but has a width, W, in the transverse direction between first and second side faces 28 and 30 which is narrower than the diameter of bucket 100, so as to leave an opening 110 to an interior of bucket 100 along side surfaces 28 and 30 of console 20. Such openings 110 provide access to an interior of bucket 100 and may be used to store various elongated items such as poles, ice skimmers, and tip-ups, for example.

By enabling console 20 to mount to multiple objects, such as to an element of a portable ice fishing shelter, and to a 5-gallon bucket, console 20 provides mobility to an ice fisherman to easily store, organize, transport, and use equipment in different scenarios (e.g., both with and without a portable shelter). Although described herein primarily in terms of ice fishing, portable shelters, such as shelter 80, and bucket 100, and, thus, console 20, can be used in other applications. For example, portable shelter 80 may be used as a hunting shelter, and bucket 100 can be used in any number of applications where console 20 may be utilized.

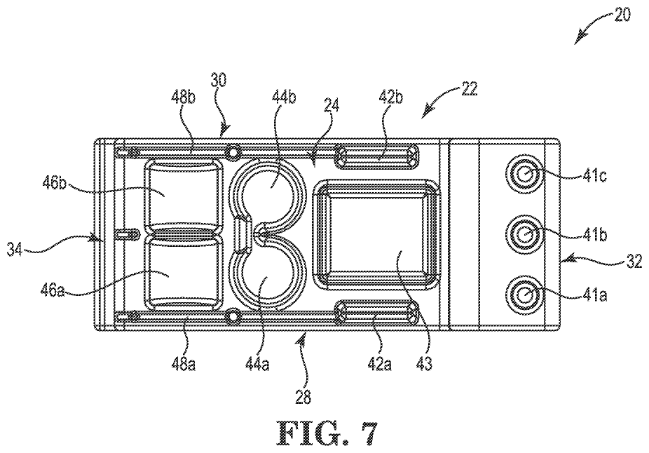

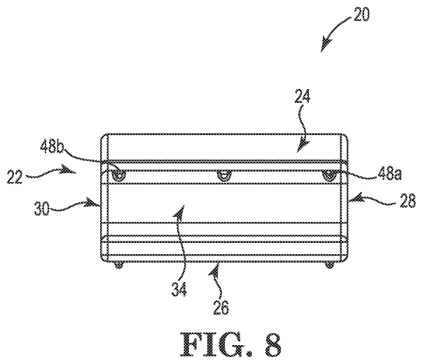

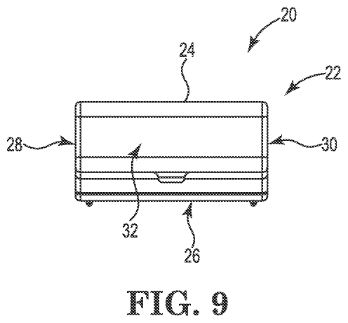

FIGS. 7-9 generally illustrate top and end views of portable storage console 20, according to one example.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A portable storage console comprising:
a body including:
an upper major surface including a number of storage compartments; and
a lower major surface opposing the upper major surface, the lower major surface including at least a first channel and a second channel, the first channel to selectively receive a component of a first fixture to releasably mount the storage console to the first fixture, and the second channel to selectively receive a component of a second fixture to releasably mount the storage console to the second fixture.

2. The storage console of claim 1, the first and second channels extending into the body from the lower major surface toward the upper major surface, wherein a mouth of the second channel is flush with the lower major surface.

3. The storage console of claim 1, the first channel having a first shape and the second channel having a second shape different from the first shape.

4. The storage console of claim 3, the first fixture comprising a base portion of a portable shelter.

5. The storage console of claim 4, the first channel being linear in shape so as to comprise a linear channel.

6. The storage console of claim 4, the component of the base portion comprising a support beam.

8. The storage console of claim 4, the second fixture comprising a bucket, the component of the second fixture comprising an upper rim of the bucket.

8. The storage console of claim 8, the second channel being arcuate in shape and having a radius matching a radius of the upper rim of the bucket.

9. The storage console of claim 8, the second channel comprising a first arcuate segment to receive a first portion of the rim of the bucket, and a second arcuate channel to receive a second portion of the rim of the bucket opposing the first portion of the rim of the bucket.

10. The storage console of claim 8, the bucket comprising a 5-gallon bucket.

11. A portable storage console comprising:
a body including:
a first major surface and an opposing second major surface;
a number of storage compartments extending into the body from the first major surface toward the second major surface; and
an arcuate channel extending into the body from the second major surface toward the first major surface, the arcuate channel to receive a rim of a 5-gallon bucket so as to releasably secure the portable storage console to the rim.

12. The portable storage console of claim 13, where a mouth of the arcuate channel is flush with the second major surface of the body.

13. The portable storage console of claim 11, the body including:
a first longitudinal side face and an opposing second longitudinal side face extending between the first and second major surfaces; and
a first transverse end face and an opposing second transverse side face extending between the first and second major surfaces and the first and second longitudinal side faces, wherein a width of the body between the first and second longitudinal side faces is less than a diameter of the 5-gallon bucket.

14. The portable storage console of claim 13, the arcuate channel comprising a first and second arcuate channel segments to receive opposing portion of the rim of the 5-gallon bucket.

15. The portable storage console of claim 12, including a linear channel extending into the body from the second major surface toward the first major surface, the linear channel to receive a portion of a base portion of a portable activity shelter so as to releasably secure the portable storage console to the shelter.

16. The portable storage console of claim 12, the console comprising a contiguous piece of material.

17. A portable ice fishing storage console comprising:
a body including:
a first major surface and an opposing second major surface;
a first longitudinal side face and an opposing second longitudinal side face extending between the first and second major surfaces; and
a first transverse end face and an opposing second transverse side face extending between the first and second major surfaces and the first and second longitudinal side faces;
a number of storage compartments extending into the body from the first major surface toward the second major surface;
a first channel extending into the body from the second major surface toward the first major surface, the first channel to receive a portion of a first device so as to releasably mount to the first device in a first mode; and
a second channel extending into the body from the second major surface toward the first major surface, the second channel to slidably receive a portion of a second device so as to mount to the second device in a second mode.

18. The portable storage console of claim 17, the first device comprising a sled of a portable ice fishing shelter in the first mode, and the second device comprising a rim of a 5-gallon bucket in the second mode.
